(19) United States
(12) Patent Application Publication
(10) Pub. No.: US 2025/0365240 A1
(43) Pub. Date: Nov. 27, 2025

(54) PACKET PROCESSING SYSTEM AND PACKET PROCESSING METHOD FOR TIME SENSITIVE NETWORKING USING A SINGLE QUEUE

(71) Applicant: TSN LAB, INC., Yongin-si (KR)

(72) Inventors: Sung Min KIM, Yongin-si (KR); Jin Won KANG, Gwangju-si (KR); Sik YOON, Seoul (KR)

(21) Appl. No.: 18/741,516

(22) Filed: Jun. 12, 2024

(30) Foreign Application Priority Data
May 24, 2024 (KR) 10-2024-0067665

(51) Int. Cl. H04L 47/2441; H04L 47/56; H04L 47/62

(52) U.S. Cl. CPC H04L 47/2441; H04L 47/562; H04L 47/6225

(57) ABSTRACT

An embodiment provides a packet processing system including a network device that transmits and receives a plurality of packets through a network and a computing device that processes the plurality of packets. The computing device generates a plurality of pieces of transmission metadata related to a quality of service (QoS) of the plurality of packets, adds the plurality of pieces of generated transmission metadata to the plurality of packets, and transmits the plurality of packets to which the plurality of pieces of transmission metadata are added to the network device. The network device transmits the plurality of packets through the network according to a transmission order determined based on the plurality of pieces of transmission metadata.

### CROSS-REFERENCE TO RELATED APPLICATION

This application claims priority to and the benefit of Korean Patent Application No. 10-2024-0067665, filed on May 24, 2024, the disclosure of which is incorporated herein by reference in its entirety.

### BACKGROUND

### 1. Field of the Invention

The present disclosure relates to packet processing technology in computer networking, and more particularly, to a packet processing system and packet processing method for time sensitive networking using a single queue.

### 2. Discussion of Related Art

IEEE time-sensitive networking (TSN) (hereinafter referred to as “TSN”) is an Ethernet-based real-time communication standard. TSN supports time synchronization, time division packet transmission, and bandwidth division packet transmission between nodes participating in a network. TSN may be applied to each device that operates infrastructure such as cars and trains. In addition, TSN may be applied in various industrial fields where data stability, real-time data transmission, and data integrity are important for accurate operation of machinery.

Data to be transmitted through a network is divided into data that requires guarantee of quality of service (QoS) and data that does not require guarantee of QoS. The QoS may have various levels and characteristics.

To ensure the QoS, a network device creates several queues for ensuring different types of QoS. The network device enqueues packets into different queues depending on QoS levels of the packets, selects a queue from the queues at a time when a packet is to be output, and dequeues the packet from the queue. Depending the QoS of data, the selection of the queue for enqueuing the packet and the timing for dequeuing the packet from the queue vary. In this way, the QoS of data is controlled.

In the related art, different queues are used depending on the QoS levels. However, high manufacturing costs are incurred to construct a plurality of queues with physical hardware. In addition, in order to ensure various types of QoS, algorithms suitable for various types of QoS should be constructed with a plurality of pieces of physical hardware. These methods incur high development costs because various algorithms should be designed in hardware.

### SUMMARY OF THE INVENTION

The present disclosure is directed to providing technical methods that can reduce the overall design and development costs of a packet processing system while ensuring various types of QoS depending on packets.

According to an aspect of the present disclosure, there is provided a packet processing system. The packet processing system includes a network device that transmits and receives a plurality of packets through a network and a computing device that processes the plurality of packets, and the computing device is configured to generate a plurality of pieces of transmission metadata related to a quality of service (QoS) of the plurality of packets, add the plurality of pieces of generated transmission metadata to the plurality of packets, and transmit the plurality of packets to which the plurality of pieces of transmission metadata are added to the network device and the network device is configured to transmit the plurality of packets through the network according to a transmission order determined based on the plurality of pieces of transmission metadata.

The computing device may include a network application for performing processing on the plurality of packets and a scheduling module that generates the plurality of pieces of transmission metadata related to the QoS of the plurality of packets and transmits the plurality of packets and the plurality of pieces of transmission metadata to the network device, and the network device may include a transmission queue that stores the plurality of packets and the plurality of pieces of transmission metadata received from the scheduling module, a transmission module that dequeues the plurality of packets stored in the transmission queue according to the transmission order determined based on the plurality of pieces of transmission metadata, and a transmission interface that transmits the plurality of dequeued packets to the network.

The computing device may include a memory and a processor, the processor of the computing device may be configured to perform a function of the scheduling module by a program stored in the memory, and the transmission module of the network device may be composed of a hardware component for performing a function of the transmission module.

The transmission metadata for each packet may include a transmission time of the corresponding packet determined according to a scheduling algorithm and a policy when transmission of the corresponding packet fails.

The transmission queue may include a single priority queue, a dequeuing order of the plurality of packets stored in the transmission queue may be determined based on a transmission time of the transmission metadata, and the transmission module may transmit the dequeued packet to the network through the transmission interface at the transmission time of the transmission metadata.

The network device may further include an offload accelerator, and the offload accelerator may encrypt the dequeued packet using an encryption key and transmit the dequeued packet to the transmission module.

According to another aspect of the present disclosure, there is provided a packet processing system. The packet processing system includes a network device that transmits and receives a plurality of packets through a network and a computing device that processes the plurality of packets, wherein the network device is configured to generate a plurality of pieces of reception metadata related to a QoS of the plurality of packets, add the plurality of pieces of generated reception metadata to the plurality of packets, and transmit the plurality of packets to which the plurality of pieces of transmission metadata are added to the computing device, and the computing device is configured to process the plurality of packets according to a processing order determined based on the plurality of pieces of reception metadata.

The network device may include a reception interface that receives the plurality of packets through the network, a reception module that generates the plurality of pieces of reception metadata related to the QoS of the plurality of received packets and adds the plurality of pieces of generated reception metadata to the plurality of packets, and a reception queue that stores the plurality of packets and the plurality of pieces of reception metadata received from the reception module, and the computing device may include a network application that performs processing on the plurality of packets and a policing module that transmits the plurality of packets stored in the reception queue to the network application according to the processing order determined based on the plurality of pieces of reception metadata.

The computing device may include a memory and a processor, the processor of the computing device may be configured to perform a function of the policing module by a program stored in the memory, and the reception module of the network device may be composed of a hardware component for performing a function of the reception module.

The reception metadata for each packet may include a reception time of the corresponding packet and information related to the QoS of the corresponding packet.

The reception queue may include a single priority queue, the processing order of the plurality of packets may be determined based on information related to a QoS of the plurality of pieces of reception metadata, and the policing module may transmit the plurality of packets to the network application according to the determined processing order.

The network device may further include an offload accelerator, and the offload accelerator may be configured to decrypt an encrypted packet received from the network using a decryption key and transmit the decrypted packet to the reception module.

The reception module may detect a packet to be dropped among the plurality of packets based on policing configuration, and may drop the detected packet to be dropped without storing the detected packet to be dropped in the reception queue.

The reception module may generate a stream ID for the plurality of received packets using predetermined packet field information, the reception metadata may include the generated stream ID, and the policing module may drop one or more received packets or control a bandwidth for the one or more received packets based on the stream ID of the reception metadata.

According to still another aspect of the present disclosure, there is provided a packet processing method that is performed by a packet processing system including a network device that transmits and receives a plurality of packets through a network and a computing device that processes the plurality of packets, the packet processing method including, by the computing device, generating a plurality of pieces of transmission metadata related to a QoS of the plurality of packets, adding the plurality of pieces of generated transmission metadata to the plurality of packets, and transmitting the plurality of packets to which the plurality of pieces of transmission metadata are added to the network device, and, by the network device, transmitting the plurality of packets through the network according to a transmission order determined based on the plurality of pieces of transmission metadata.

According to yet another aspect of the present disclosure, there is provided a packet processing method. The packet processing method is performed by a packet processing system including a network device that transmits and receives a plurality of packets through a network and a computing device that processes the plurality of packets, the packet processing method including, by the computing device, generating a plurality of pieces of transmission metadata related to a QoS of the plurality of packets, adding the plurality of pieces of generated transmission metadata to the plurality of packets, and transmitting the plurality of packets to which the plurality of pieces of transmission metadata are added to the network device, and, by the network device, transmitting the plurality of packets through the network according to a transmission order determined based on the plurality of pieces of transmission metadata.

According to yet another aspect of the present disclosure, there is provided a packet processing method. The packet processing method is performed by a packet processing system including a network device that transmits and receives a plurality of packets through a network and a computing device that processes the plurality of packets, the packet processing method including, by the network device, generating a plurality of pieces of reception metadata related to a QoS of a plurality of packets, adding the plurality of pieces of generated reception metadata to the plurality of packets, and transmitting the plurality of packets to which the plurality of pieces of transmission metadata are added to the computing device, and by the computing device, processing the plurality of packets according to a processing order determined based on the plurality of pieces of reception metadata.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is an exemplary block diagram of a packet processing system including a plurality of transmission queues and reception queues;

FIG. 2 is an exemplary configuration diagram of a packet processing system including a single transmission queue and a single reception queue;

FIG. 3 is a diagram illustrating a packet structure including transmission metadata generated by a scheduling module;

FIG. 4 is a flowchart illustrating a packet transmission process;

FIG. 5 is a diagram illustrating a packet structure including reception metadata generated by a reception module;

FIG. 6 is a flowchart illustrating a packet reception process according to an embodiment of the present disclosure;

FIG. 7 is an exemplary diagram illustrating a packet processing system that further includes an offload accelerator; and

FIG. 8 illustrates an exemplary computing device according to various embodiments.

### DETAILED DESCRIPTION OF EXEMPLARY EMBODIMENTS

Specific structural and step-by-step descriptions of examples of the present disclosure are merely for illustrating examples according to the concept of the present disclosure. Accordingly, examples according to the concept of the present disclosure may be implemented in various forms. The present disclosure should not be construed as being limited to the examples thereof.

Various changes may be made to the examples according to the concept of the present disclosure, and the examples may take various forms. Accordingly, specific examples will be illustrated in the accompanying drawings and described in detail in the present disclosure or application. However, this is not intended to limit the examples according to the concepts of the present disclosure to a specific form of disclosure. It should be understood that the examples according to the concept of the present disclosure include all changes, equivalents, and substitutes included in the spirit and technical scope of the present disclosure.

Terms such as “first,” “second,” etc. used in this specification may be used to describe various components, but the components should not be limited by the terms. The terms may be used for the purpose of distinguishing one component from another. Without departing from the scope of rights according to the concept of the present disclosure, a “first component” may be named a “second component,” and similarly, a “second component” may also be named a “first component.”

When a component is described as being “coupled” or “connected” to another component, it should be understood that the component may be directly coupled or connected to the other component. However, it should be understood that other components may exist among a plurality of components. On the other hand, when a component is described as being “directly coupled” or “directly connected” to another component, it should be understood that there are no other components between the component and the other component. Other expressions describing a relationship between components, such as “between” and “directly between,” or “adjacent to” and “directly adjacent to,” should be interpreted similarly.

The terms used in this disclosure are only used to describe specific examples and are not intended to limit the present disclosure. Singular expressions include plural expressions unless the context clearly dictates otherwise. In the present disclosure, terms such as “comprise” or “have” are intended to designate the presence of described features, numbers, steps, operations, components, parts, or combinations thereof. Accordingly, it should be understood that this does not exclude in advance the presence or addition of one or more other features, numbers, steps, operations, components, parts, or combinations thereof.

Unless otherwise defined, all terms used herein, including technical or scientific terms, have the same meaning as commonly understood by those skilled in the art to which the present disclosure pertains. Terms defined in commonly used dictionaries should be interpreted as having a meaning consistent with the meaning they have in the context of the relevant technology. In addition, terms such as those defined in commonly used dictionaries are not to be interpreted with idealized or overly formal meanings unless clearly defined in the present disclosure.

In describing the examples, description of technical content that is well known in the technical field to which the present disclosure pertains and that are not directly related to this disclosure will be omitted. This is to convey the gist of the present disclosure more clearly without obscuring the gist of the present disclosure, by omitting unnecessary description.

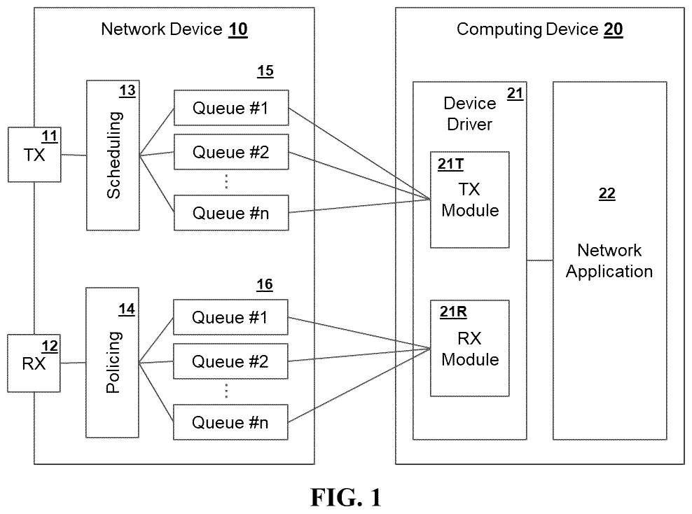

FIG. 1 is an exemplary block diagram of a packet processing system including a plurality of transmission queues and reception queues

Referring to FIG. 1, a packet processing system 1 may include a network device 10 and a computing device 20.

The network device 10 is a device connected to a network to transmit or receive data. The network device 10 may transmit or receive data based on a packet. The network device 10 may transmit a packet to the network using a transmission port and receive a packet from the network using a reception port.

The network device 10 may include a transmission interface 11, a reception interface 12, a scheduling module 13, a policing module 14, a plurality of transmission queues 15, and a plurality of reception queues 16.

The transmission interface 11 is an interface for transmitting a packet to the network. The reception interface 12 is an interface for receiving a packet from the network.

The scheduling module 13 determines which queue to be selected from among a plurality of queues when transmitting a packet to the network. The scheduling module 13 may determine which queue to be selected from among the plurality of queues at the current point in time and how to process the packet when transmission of the packet fails. The scheduling module 13 may select a different queue depending on a size of the packets stored in the queue.

When receiving a packet from the network, the policing module 14 may determine which packet to be enqueued into which queue or whether to drop the packet.

The plurality of transmission queues 15 are physical queues connected to the scheduling module 13. The plurality of transmission queues 15 consist of a plurality of memory areas with a fixed size.

The plurality of reception queues 16 are physical queues connected to the policing module 104. The plurality of reception queues 16 includes a plurality of memory areas with a fixed size.

The computing device 20 uses the network device 10, and may include a central processing unit (CPU) and a memory. The computing device 20 generates data, divides the data based on a packet, and sends packets to the network device 10. In addition, the computing device 20 may receive a packet from the network device 10 and process data.

The computing device 20 may include a device driver 21 and a network application 22. The device driver 21 may include a transmission module 21T and a reception module 21R.

The device driver 21 is a device driver that operates on an operating system of the computing device 20, and is a software-based component for controlling the network device 10.

The transmission module 21T determines which queue among the plurality of transmission queues 15 to enqueue a packet and enqueues the packet into one determined queue in order to ensure QoS based on a packet. The reception module 21R determines a priority for which of the plurality of reception queues 16 to read a packet from.

The network application 22 generates data to be transmitted to the network device 10 and processes data received from the network device 10.

In a structure of the packet processing system 1 illustrated in FIG. 1, the network device 10 performs QoS guarantee. The packet processing system 1 provides a plurality of queues according to a plurality of QoS levels to ensure the QoS based on a packet.

The hardware-based scheduling module 13 having a complex configuration is included in the packet processing system 1 in order to determine to which of the plurality of queues the enqueued packet should be output first. In addition, the hardware-based policing module 14 having a complex configuration is included in the packet processing system 1 in order to determine which packet to be received first and which queue to enqueue the received packet into.

In this configuration, most processing for packet scheduling is performed in the network device 10, and the network device 10 has a very complex structure. The device driver 21 of the computing device 20 has a relatively simple structure compared to the network device 10.

Since the network device 10 includes hardware-based components, development and manufacturing costs are high. Since the computing device 20 includes software-based components, development and manufacturing costs thereof are relatively low.

In the example illustrated in FIG. 1, complex functions are concentrated in the network device 10 having relatively high development and manufacturing costs, and simple functions are installed in the computing device 20 having relatively low development and manufacturing costs.

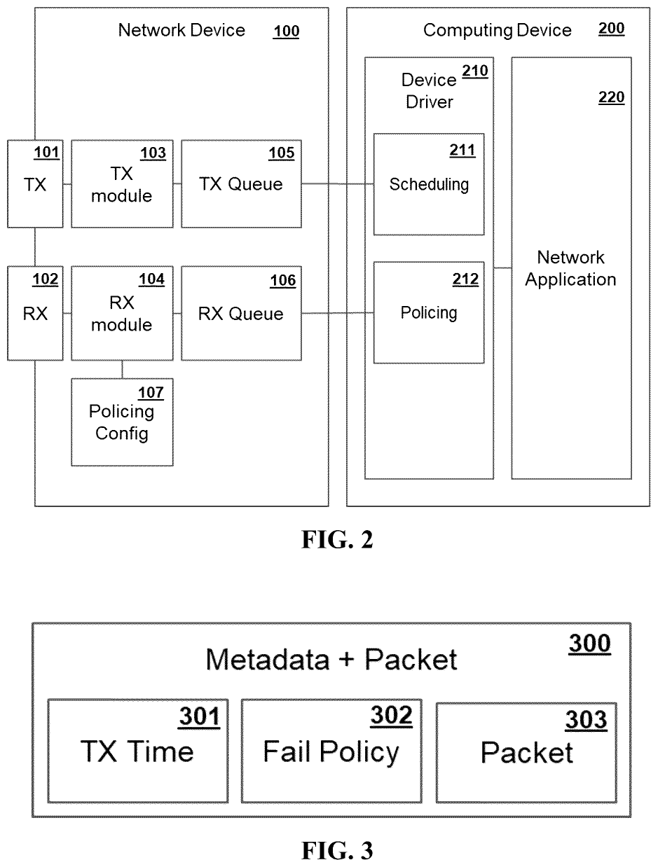

FIG. 2 is an exemplary configuration diagram of a packet processing system 2 including a single transmission queue and a single reception queue

Referring to FIG. 2, the packet processing system 2 may include a network device 100 and a computing device 200. The network device 100 may transmit and receive a plurality of packets through a network. The computing device 200 may process the plurality of packets.

The computing device 200 may include a network application 220 and a device driver 210. The device driver 210 may include a scheduling module 211 and a policing module 212.

The network device 100 may include a transmission interface 101, a reception interface 102, a transmission module 103, a reception module 104, a transmission queue 105, a reception queue 106, and policing configuration 107.

The network application 220 may perform processing on the plurality of packets. The network application 220 may transmit the plurality of packets that are transmission targets to the scheduling module 211 of the device driver 210. The scheduling module 211 may generate a plurality of pieces of transmission metadata related to the QoS of a plurality of packets, and transmit the plurality of packets and the plurality of pieces of transmission metadata to the network device 100.

The transmission queue 105 may store the plurality of packets and the plurality of pieces of transmission metadata received from the scheduling module 211. The transmission queue 105 may include a single priority queue, such as a shift register priority queue, a systolic array priority queue, a modified systolic array priority queue, and a multiple systolic array priority queue. When one packet is enqueued, the transmission queue 105 may determine an output priority of the enqueued packet based on transmission metadata of the enqueued packet, and update output priorities of a plurality of packets stored in the transmission queue 105.

The transmission module 103 may dequeue the plurality of packets stored in the transmission queue 105 according to a transmission order determined based on a plurality of pieces of transmission metadata. The transmission interface 101 may transmit a plurality of dequeued packets to the network.

The reception interface 102 may receive a plurality of packets through the network. The reception module 104 may determine which packets to be dropped and which packets to be acquired based on the policing configuration 107.

The reception module 104 may generate a plurality of pieces of reception metadata related to the QoS of a plurality of received packets, and add the plurality of pieces of generated reception metadata to the plurality of packets.

The reception queue 106 may store the plurality of packets and the plurality of pieces of reception metadata received from the reception module 104. The reception queue 106 may include a single priority queue, such as the shift register priority queue, the systolic array priority queue, the modified systolic array priority queue, and the multiple systolic array priority queue. When one packet is enqueued, the reception queue 106 may determine an output priority of the enqueued packet based on the reception metadata of the enqueued packet, and update output priorities of a plurality of packets stored in the reception queue 106.

The policing module 212 may transmit the plurality of packets stored in the reception queue 106 to the network application 220 according to a processing order determined based on a plurality of pieces of reception metadata. The network application 220 may process the plurality of received packets.

The computing device 200 may include a plurality of memories and one or more processors. One or more processors of the computing device 200 may be configured to perform a function of the scheduling module 211 by a program stored in the memory. That is, the scheduling module 211 is a software-based component.

In addition, one or more processors of the computing device 200 may be configured to perform a function of the policing module 212 by a program stored in the memory. That is, the policing module 212 is a software-based component.

The transmission module 103 of the network device 100 may be configured of a hardware component for performing the function described above of the transmission module 103. In addition, the reception module 104 of the network device 100 may be configured of a hardware component for performing the function described above of the reception module 104.

In the packet processing system 2, most of the scheduling algorithm and policing algorithm are performed in the software-based device driver 210. The functions that need to be performed in hardware in order to ensure the QoS are kept to a minimum in the transmission module 103 and the reception module 104.

The packet processing system 2 having the structure described above may support the TSN that configures the QoS based on a packet and ensures the QoS based on a packet. The packet processing system 2 does not physically use a plurality of queues, but uses a single transmission queue and a single reception queue. The packet processing system 2 includes a single transmission queue and a single reception queue, but may logically operate as when using a plurality of queues using transmission metadata and reception metadata.

That is, according to the present disclosure, the effect of logically using the plurality of queues may be achieved using one physical queue and packet-level metadata having scheduling information. By using a single physical queue, hardware production costs can be reduced. Hardware development costs can be significantly reduced by processing most of the scheduling algorithm that runs on hardware in software.

In general, since the development costs of hardware are tens to hundreds of times higher than the development costs of software, the overall development cost of the system is also lowered. In addition, it is faster to run the scheduling algorithm in software compared to running the scheduling algorithm in hardware. Therefore, according to the method of the present disclosure, packet processing time is also shortened. In addition, it is possible to implement scheduling without QoS degradation by precisely designing metadata of a packet for scheduling.

FIG. 3 is a diagram illustrating a packet structure including transmission metadata generated by the scheduling module 211.

In order to perform most of the scheduling algorithm and policing algorithm in the scheduling module 211 and policing module 212 and maintain the minimum functions to ensure real-time performance in the transmission module 103 and reception module 104, metadata to store a processing result of the scheduling algorithm is required. When enqueuing a packet into the transmission queue 105, the scheduling module 211 adds metadata 301 and 302 for scheduling to the packet.

Referring to FIG. 3, the scheduling module 211 may generate an extended packet 300 including the transmission metadata 301 and 302 and a packet 303. The extended packet 300 may be generated by adding the transmission metadata 301 and 302 to the packet 303 to be transmitted. The transmission metadata may include a transmission time 301 and a fail policy 302 of the corresponding packet.

The transmission time 301 is metadata for scheduling. The transmission time 301 is information indicating when to transmit a packet. Nanoseconds may be used for the transmission time 301.

The transmission time 301 may be determined according to a scheduling policy of the packet. The scheduling module 211 may determine a slice to which a packet is output according to a transmission period and transmission bandwidth of the enqueued packet. A plurality of packets are arranged in each slice. The scheduling module 211 may determine the transmission time 301 of the enqueued packet by considering the priorities of the plurality of packets already arranged in the slice and the priority of the enqueued packet.

The transmission time 301 may include information indicating a time range of packet transmission. The transmission time 301 may include a first time and a second time. The first time may indicate a start time at which packet transmission is possible, and the second time may indicate an end time at which packet transmission is possible. The packet not transmitted between the first time (start time) and the second time (end time) may be processed according to the fail policy 302.

The transmission time 301 may include information indicating a time range during which the packet should be output from the transmission queue 105 when packet transmission is delayed (when the packet is not transmitted between the first time and the second time).

In addition, when determining the transmission time 301, transmission delay of the packet may be considered. For example, the transmission delay may include the time taken to process packets by the scheduling algorithm, transmission delay from the scheduling module 211 to the transmission queue 105, the transmission delay from the transmission queue 105 to the transmission module 103, and the transmission delay from the transmission module 103 to the transmission interface 101.

The fail policy 302 is metadata for scheduling. The fail policy 302 is information indicating a policy for whether the corresponding packet should be reordered in the queue according to what criteria or the corresponding should be dropped when the packet fails to be transmitted during the configured transmission time 301.

By using the transmission metadata 301 and 302, most scheduling algorithms may be implemented. For example, the IEEE 802.1Qav bandwidth control standard and the IEEE 802.1Qbv time division transmission standard enable scheduling algorithms to be implemented by precisely configuring the transmission time 301. When packet transmission fails, the scheduling algorithm can be implemented by changing the transmission time 301 by referring to the fail policy 302.

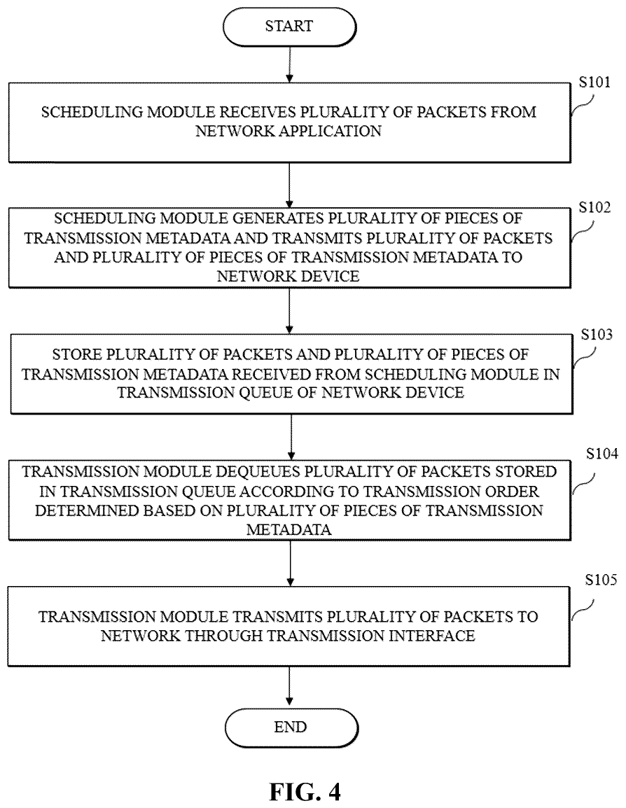

FIG. 4 is a flowchart illustrating a packet transmission process

The scheduling module 211 receives a plurality of packets 303 from the network application 220 (operation S101).

The scheduling module 211 generates a plurality of pieces of transmission metadata 301 and 302 and transmits the plurality of packets 303 and the plurality of pieces of transmission metadata 301 and 302 to the network device 100 (operation S102).

The transmission queue 105 of the network device 100 stores the plurality of packets 303 and the plurality of pieces of transmission metadata 301 and 302 received from the scheduling module 211 (operation S103).

The transmission module 103 dequeues the plurality of packets 303 stored in the transmission queue according to a transmission order determined based on the plurality of pieces of transmission metadata 301 and 302 (operation S104).

The transmission module 103 transmits the plurality of packets 303 to the network through the transmission interface 101 (operation S105).

Regarding the packet transmission process including operations S101 to S105, the descriptions of the network application 220, the scheduling module 211, the transmission metadata 301 and 302, the transmission queue 105, the transmission module 103, and the transmission interface 101 above may be referenced.

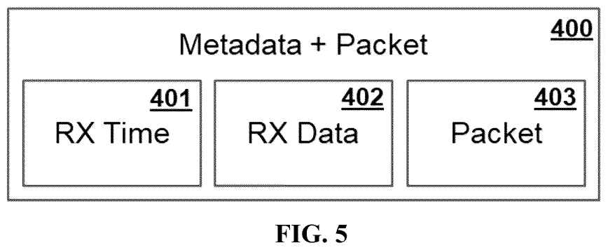

FIG. 5 is a diagram illustrating a packet structure including reception metadata generated by the reception module 104.

Referring to FIG. 5, the reception module 104 may generate an extended packet 400 including reception metadata 401 and 402 and a packet 403. The extended packet 400 may be generated by adding the reception metadata 401 and 402 to a received packet 403. The reception metadata 401 and 402 may include a reception time 401 and QoS summary information 402 of the corresponding packet.

The reception time 401 is information indicating the time when a packet was received. Nanoseconds may be used for the reception time 401.

The QoS summary information 402 is summary information through which QoS information of the packet is identified. The QoS summary information 402 is data that should be processed at a high speed using hardware. The QoS summary information 402 may include information such as a virtual local area network (VLAN) ID, a source medium access control (MAC) address, and a destination MAC address of the packet.

When receiving the packet 403, the reception module 104 generates the QoS summary information 402 based on the policing configuration 107 and information of the packet 403. When the reception module 104 detects a packet that should be dropped, the reception module 104 immediately drops the received packet. The reception module 104 generates the reception time 401 based on the current time at the time of packet reception. The reception module 104 generates the extended packet 400 including the reception time 401, the QoS summary information 402, and the packet 403, and enqueues the extended packet 400 into the reception queue 106.

According to the processing of the reception module 104 described above, the reception module 104 is in charge of processing to drop packets in real time. In addition, real-time performance of a packet may be ensured by the policing module 212 using the QoS summary information 402 generated at a high speed through hardware. Most of the policing algorithm may be implemented by the software-based policing module 212.

According to this method, most policing algorithms may be implemented. For example, the IEEE 802.1Qci Per-Stream Filtering and Policing standard classifies packets into streams when receiving the packets, and selectively drops packets or adjusts a bandwidth on a stream basis. This process may be implemented by the packet processing system 2.

First, an example of packet dropping will be described. The computing device 200 stores information about a field of the packet on which to generate stream information in the policing configuration 107 in advance. The reception module 104 uses packet field information in the policing configuration 107 to generate the QoS summary information 402 including a stream ID. For example, in a packet of the IEEE 802.1Q protocol (including a MAC destination, a MAC source, an 802.1Q header (VLAN ID and VLAN priority), an EtherType, and a payload), the stream ID may be determined by combining the MAC destination, the MAC source, the VLAN ID, the VLAN priority, and the EtherType. A user may determine what information is used to generate the stream ID.

The reception module 104 checks a policy stored in the policing configuration 107 based on the QoS summary information 402 of the packet. When the stream ID of the Qos summary information 402 matches the stream ID of the policing configuration 107 and the corresponding policy is drop, the reception module 104 drops the packet. The network application 220 may confirm that a specific stream has been filtered.

Next, an example of bandwidth adjustment will be described. The network application 220 stores information about a field of the packet on which to generate stream information in the policing configuration 107 in advance. The reception module 104 uses the packet field information in the policing configuration 107 to generate the QoS summary information 402 including the stream ID.

The reception module 104 checks the policy stored in the policing configuration 107 based on the QoS summary information 402 of the packet. When the stream ID of the QoS summary information 402 matches the stream ID of the policing configuration 107 and the corresponding policy is pass, the reception module 104 enqueues the packet into the reception queue 106. The reception module 104 generates the extended packet 400 and enqueues the extended packet 400 into the reception queue 106. In other cases, the reception module 104 drops the packet.

The policing module 212 fetches a packet from the reception queue 106 and ascertains the stream ID from the QoS summary information 402. The policing module 212 runs a bandwidth control algorithm for each stream ID to adjust the time for transmitting the packet to the network application 220. The network application 220 may obtain a result where the bandwidth is controlled for a specific stream.

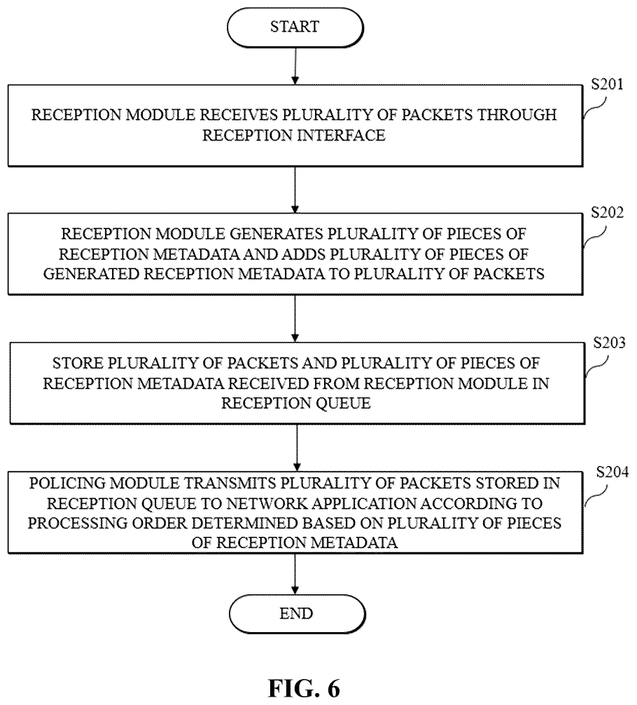

FIG. 6 is a flowchart illustrating a packet reception process according to an embodiment of the present disclosure.

The reception module 104 receives a plurality of packets 403 through the reception interface 102 (operation S201).

The reception module 104 generates a plurality of pieces of reception metadata 401 and 402, and adds the plurality of pieces of generated reception metadata 401 and 402 to the plurality of packets 403 (operation S202).

The reception queue 106 stores the plurality of packets 403 and the plurality of pieces of reception metadata 401 and 402 received from the reception module 104 (operation S203).

The policing module 212 transmits the plurality of packets 403 stored in the reception queue 106 to the network application 220 according to a processing order determined based on the plurality of pieces of reception metadata 401 and 402 (operation S204).

Regarding the packet reception process including operations S201 to S204, the description of the reception interface 102, the reception module 104, the reception queue 106, the policing module 212, and the network application 220 above may be referenced.

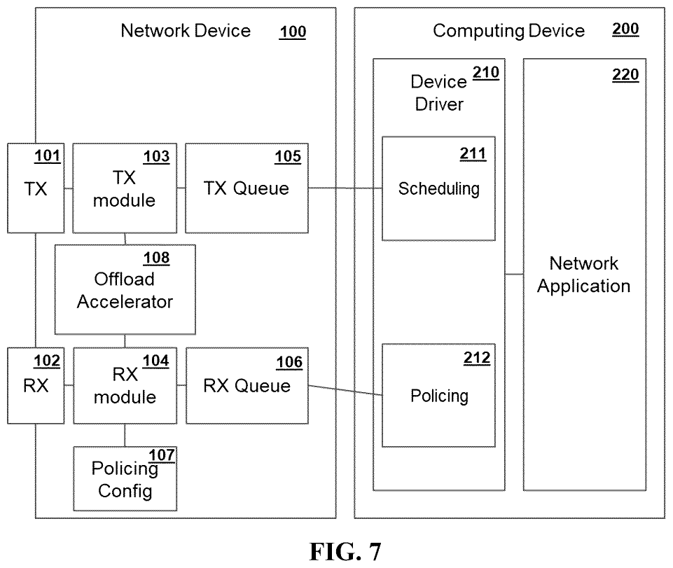

FIG. 7 is an exemplary diagram illustrating a packet processing system 3 that further includes an offload accelerator

Referring to FIG. 7, the network device 100 further includes an offload accelerator 108. The offload accelerator 108 may be connected to the transmission module 103 and the reception module 104.

The offload accelerator 108 may include an encryption and decryption accelerator to perform encryption and decryption at a high speed, an address lookup table to match IP addresses with rules at a high speed, a random number generator (RNG) to generate random numbers, and the like. The offload accelerator 108 is a hardware-based component.

A process of encrypting and decrypting packets at a high speed using the offload accelerator 108 is as follows.

The network application 220 transmits an unencrypted packet to the scheduling module 211. The scheduling module 211 transmits the unencrypted packet along with transmission metadata to the transmission queue 105. The transmission module 103 dequeues the unencrypted packet from the transmission queue 105 and encrypts the packet using the offload accelerator 108.

An encrypted packet is received through the reception interface 102. The reception module 104 decrypts the encrypted packet through the offload accelerator 108. The reception module 104 enqueues the decrypted packet along with reception metadata in the reception queue 106. The policing module 212 receives the decrypted packet from the reception queue 106 and sends the decrypted packet to the network application 220 according to a determined processing speed.

A process of protecting the encryption key using the offload accelerator 108 is as follows.

The network application 220 enqueues an unencrypted packet into the transmission queue 105 through the scheduling module 211. The transmission module 103 generates random numbers through the offload accelerator 108 and generates a public key and private key pair using the random numbers. The private key is stored in the offload accelerator 108, and the public key is transmitted to the network application 220 and used in the network application 220. The transmission module 103 encrypts the unencrypted packet using the private key stored in the offload accelerator 108 and transmits the encrypted packet to the network through the transmission interface 101.

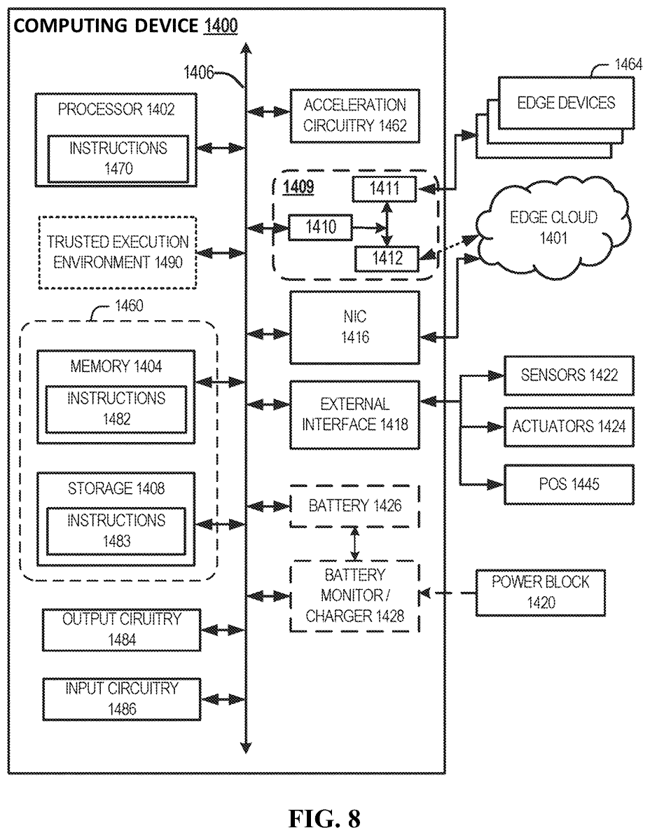

FIG. 8 illustrates an exemplary computing device 1400 according to various embodiments. In various embodiments, the computing device 1400 may be used to implement the computing device 200 supporting the TSN as described throughout the present disclosure.

In some embodiments, for example, a network interface controller (NIC) 1416 of the computing device 1400 may be used to implement the network device 100 that supports the TSN as described throughout the present disclosure.

In various embodiments, the computing device 1400 may be suitable for use as any other element/device discussed herein with respect to any other figure shown or described herein. The computing device 1400 may also be implemented in or as a server computer system or some other element, device, or system discussed herein. The computing device 1400 may include any combinations of the components illustrated in an example of FIG. 8. The components of the computing device 1400 may be implemented as integrated circuits (ICs), parts thereof, individual electronic devices, or other modules, logic, hardware, software, firmware, or combinations thereof adapted to the computing device 1400, or as components otherwise integrated within a chassis of a larger system.

The example of FIG. 8 is intended to illustrate a high level view of the components of the computing device 1400. However, some of the illustrated components may be omitted, additional components may be present, and different arrangements of the illustrated components may be adopted in other implementations.

The computing device 1400 includes a processor circuit 1402. The processor circuit 1402 includes, but is not limited to, circuitry such as one or more of one or more processor cores and cache memories, low drop-out voltage regulators (LDOs), interrupt controllers, serial interfaces such as SPIs, I2Cs or universal programmable serial interface circuits, timers/counters including real time clocks (RTCs), interval timers, and watchdog timers, memory card controllers such as universal I/Os, secure digital/multi-media cards (SD/MMCs) or similar interfaces, mobile industry processor interface (MIPI) interfaces, and Joint Test Access Group (JTAG) test access ports. In some implementations, the processor circuit 1402 may include one or more hardware accelerators, which may be microprocessors, programmable processing devices, (e.g., field-programmable gate arrays (FPGAs), application-specific integrated circuits (ASICs), etc.), and the like. One or more hardware accelerators may include, for example, computer vision and/or deep learning accelerators. In some implementations, the processor circuit 1402 may include an on-chip memory circuit, which may include any suitable volatile and/or non-volatile memory, such as a dynamic random access memory (DRAM) a static random access memory (SRAM), an erasable and programmable-read only memory (EPROM), an electrical EPROM (EEPROM), a flash memory, a solid-state memory, and/or any other type of memory device technology, such as those discussed herein.

Processor(s) of the processor circuit 1402 may include, for example, one or more processor cores (CPUs), application processors, GPUs, reduced instruction set computer (RISC) processors, Acorn RISC Machine (ARM) processors, and complex instruction set computer (CISC) processors, one or more digital signal processors (DSPs), one or more FPGAs, one or more programmable logic devices (PLDs), one or more ASICs, one or more baseband processors, one or more radio frequency integrated circuits (RFICs), one or more microprocessors or controllers, or any suitable combination thereof. Processors (or cores) of the processor circuit 1402 may be coupled to or include a memory/storage, and may be configured to execute instructions stored in the memory/storage to enable various applications or operating systems to run on the device 1400. In these embodiments, the processors (or cores) of the processor circuit 1402 are configured to operate application software to provide specific services to a user of the computing device 1400. In some embodiments, the processor circuit 1402 may be a special-purpose processor/controller that operates in accordance with various embodiments herein.

According to embodiments of the present disclosure, a software-based computing device performs major packet processing for packet scheduling and policing and minimizes packet processing for the packet scheduling and policing performed by a hardware-based network device, and can thereby reduce the overall design and development costs of the packet processing system while ensuring various types of QoS depending on packets.

Although embodiments have been described above with reference to limited drawings, those skilled in the art can make various modifications and variations from the above description. For example, even when the described techniques are performed in a different order from the methods described, and/or the components of the systems, structures, devices, circuits, and the like described are coupled or combined in a different form from the described methods, or are substituted or replaced by other components or equivalents, appropriate results can be achieved.

Therefore, other implementations, other embodiments, and equivalents to the claims also fall within the scope of the claims described below.

1. A packet processing system comprising:
a network device that transmits and receives a plurality of packets through a network; and
a computing device that processes the plurality of packets,
wherein the computing device is configured to generate a plurality of pieces of transmission metadata related to a quality of service (QoS) of the plurality of packets, add the plurality of pieces of generated transmission metadata to the plurality of packets, and transmit the plurality of packets to which the plurality of pieces of transmission metadata are added to the network device, and
the network device is configured to transmit the plurality of packets through the network according to a transmission order determined based on the plurality of pieces of transmission metadata.

2. The packet processing system of claim 1, wherein:
the computing device includes:
a network application for performing processing on the plurality of packets; and
a scheduling module that generates the plurality of pieces of transmission metadata related to the QoS of the plurality of packets and transmits the plurality of packets and the plurality of pieces of transmission metadata to the network device, and
the network device includes:
a transmission queue that stores the plurality of packets and the plurality of pieces of transmission metadata received from the scheduling module;
a transmission module that dequeues the plurality of packets stored in the transmission queue according to the transmission order determined based on the plurality of pieces of transmission metadata; and
a transmission interface that transmits the plurality of dequeued packets to the network.

3. The packet processing system of claim 2, wherein:
the computing device includes a memory and a processor;
the processor of the computing device is configured to perform a function of the scheduling module by a program stored in the memory; and
the transmission module of the network device is composed of a hardware component for performing a function of the transmission module.

4. The packet processing system of claim 2, wherein the transmission metadata for each packet includes a transmission time of the corresponding packet determined according to a scheduling algorithm and a policy when transmission of the corresponding packet fails.

5. The packet processing system of claim 2, wherein:
the transmission queue includes a single priority queue;
a dequeuing order of the plurality of packets stored in the transmission queue is determined based on a transmission time of the transmission metadata; and
the transmission module transmits the dequeued packet to the network through the transmission interface at the transmission time of the transmission metadata.

6. The packet processing system of claim 2, wherein:
the network device further includes an offload accelerator; and
the offload accelerator encrypts the dequeued packet using an encryption key and transmits the dequeued packet to the transmission module.

7. A packet processing system comprising:
a network device that transmits and receives a plurality of packets through a network; and
a computing device that processes the plurality of packets,
wherein the network device is configured to generate a plurality of pieces of reception metadata related to a quality of service (QoS) of the plurality of packets, add the plurality of pieces of generated reception metadata to the plurality of packets, and transmit the plurality of packets to which the plurality of pieces of transmission metadata are added to the computing device, and
the computing device is configured to process the plurality of packets according to a processing order determined based on the plurality of pieces of reception metadata.

8. The packet processing system of claim 7, wherein:
the network device includes:
a reception interface that receives the plurality of packets through the network;
a reception module that generates the plurality of pieces of reception metadata related to the QoS of the plurality of received packets and adds the plurality of pieces of generated reception metadata to the plurality of packets; and
a reception queue that stores the plurality of packets and the plurality of pieces of reception metadata received from the reception module, and
the computing device includes:
a network application that performs processing on the plurality of packets; and
a policing module that transmits the plurality of packets stored in the reception queue to the network application according to the processing order determined based on the plurality of pieces of reception metadata.

9. The packet processing system of claim 8, wherein:
the computing device includes a memory and a processor;
the processor of the computing device is configured to perform a function of the policing module by a program stored in the memory; and
the reception module of the network device is composed of a hardware component for performing a function of the reception module.

10. The packet processing system of claim 8, wherein the reception metadata for each packet includes a reception time of the corresponding packet and information related to the QoS of the corresponding packet.

11. The packet processing system of claim 8, wherein:
the reception queue includes a single priority queue;
the processing order of the plurality of packets is determined based on information related to a QoS of the plurality of pieces of reception metadata; and
the policing module transmits the plurality of packets to the network application according to the determined processing order.

12. The packet processing system of claim 8, wherein:
the network device further includes an offload accelerator; and
the offload accelerator is configured to decrypt an encrypted packet received from the network using a decryption key and transmit the decrypted packet to the reception module.

13. The packet processing system of claim 8, wherein the reception module detects a packet to be dropped among the plurality of packets based on a policing configuration, and drops the detected packet to be dropped without storing the detected packet to be dropped in the reception queue.

14. The packet processing system of claim 8, wherein:
the reception module generates a stream ID for the plurality of received packets using predetermined packet field information;
the reception metadata includes the generated stream ID; and
the policing module drops one or more received packets or controls a bandwidth for the one or more received packets based on the stream ID of the reception metadata.

15. A packet processing method that is performed by a packet processing system including a network device that transmits and receives a plurality of packets through a network and a computing device that processes the plurality of packets, the packet processing method comprising:
by the computing device, generating a plurality of pieces of transmission metadata related to a quality of service (QoS) of the plurality of packets, adding the plurality of pieces of generated transmission metadata to the plurality of packets, and transmitting the plurality of packets to which the plurality of pieces of transmission metadata are added to the network device; and
by the network device, transmitting the plurality of packets through the network according to a transmission order determined based on the plurality of pieces of transmission metadata.

16. (canceled)
